(19) United States
(12) Patent Application Publication
(10) Pub. No.: US 2026/0368551 A1
(43) Pub. Date: Nov. 19, 2026

(54) GENERATING FUSED MACHINE LEARNING MAPS OF BIOLOGICAL DATA UTILIZING LATE FUSION TECHNIQUES

(71) Applicant: Recursion Pharmaceuticals, Inc., Salt Lake City, UT (US)

(72) Inventors: Grant Hamilton WATSON, Toronto (CA); Kshitij Yogesh GUPTA, Brampton (CA); Oren Zeev KRAUS, Toronto (CA); Seyed Ali MADANI TONEKABONI, Toronto (CA)

(21) Appl. No.: 19/207,005

(22) Filed: May 13, 2025

(51) Int. Cl. G06N 5/022; G06F 18/25

(52) U.S. Cl. CPC G06N 5/022; G06F 18/25

(57) ABSTRACT

The present disclosure relates to systems, non-transitory computer-readable media, and methods for fusing machine learning maps of biology. In particular, in some embodiments, the disclosed systems generate a first machine learning map comprising a first set of similarity metrics between cell perturbations by comparing a first set of functional response embeddings of the cell perturbations. Additionally, in some embodiments, the disclosed systems generate a second machine learning map comprising a second set of similarity metrics between the cell perturbations by comparing a second set of functional response embeddings of the cell perturbations. Moreover, in some embodiments, the disclosed systems generate a fused map by using late fusion to combine the first machine learning map and the second machine learning map. Furthermore, in some embodiments, the disclosed systems utilize the fused map to determine a predicted relationship between a first perturbation and a second perturbation of the cell perturbations.

### BACKGROUND

Recent years have seen developments in hardware and software platforms for training and utilizing machine learning models for generating predictions. For example, existing systems utilize large volumes of training data to teach machine learning models to generate intelligent predictions corresponding to complex biological interactions between genes, compounds, and/or proteins. Despite these recent developments, existing systems suffer from a number of technical deficiencies, particularly with regard to accuracy and operational flexibility in implementing machine learning technologies.

### BRIEF SUMMARY

Embodiments of the present disclosure provide benefits and/or solve one or more problems in the art with systems, non-transitory computer-readable media, and methods for fusing machine learning maps of biology utilizing late fusion techniques. To illustrate, in one or more embodiments, the disclosed systems generate (or access) a plurality of machine learning maps, each machine learning map having similarity metrics between cell perturbations. For example, in one or more embodiments, the disclosed systems compare embeddings of a set of functional response machine learning embeddings to determine the similarity metrics. Moreover, in one or more embodiments, the disclosed systems utilize late fusion to combine the plurality of machine learning maps to generate a fused machine learning map of biology. For instance, the fused machine learning map is an aggregation of biological information from different data types or model systems. Furthermore, in one or more embodiments, the disclosed systems utilize the fused machine learning map to determine one or more predictions of biological relationships. For example, the disclosed systems determine a similarity between two perturbations.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates an overview of a map fusion system in accordance with one or more embodiments.

FIG. 2 illustrates the map fusion system generating a fused machine learning map across multiple biological model systems, biological modalities, and/or cell lines in accordance with one or more embodiments.

FIG. 3 illustrates the map fusion system generating a fused machine learning map from a weighted combination of input machine learning maps in accordance with one or more embodiments.

FIG. 4 illustrates the map fusion system generating a fused machine learning map by generating and fusing network graphs in accordance with one or more embodiments.

FIG. 5 illustrates the map fusion system utilizing a similarity network fusion model to generate a fused graph in accordance with one or more embodiments.

FIG. 6 illustrates a diagram of an environment in which a map fusion system operates in accordance with one or more embodiments.

FIG. 7 illustrates a flowchart of a series of acts for generating and utilizing a fused machine learning map in accordance with one or more embodiments.

FIG. 8 illustrates a block diagram of an example computing device for implementing one or more embodiments of the present disclosure.

### DETAILED DESCRIPTION

This disclosure describes one or more embodiments of a map fusion system that generates fused maps with enhanced data signals representing biological relationships of cellular responses to cell perturbations (e.g., chemical compound treatments, gene knockout sequences, etc.). To illustrate, in one or more embodiments, the map fusion system accesses a plurality of machine learning maps that store similarity metrics for cell perturbation pairs. For example, in one or more embodiments, the map fusion system generates the machine learning maps by comparing embeddings within a set of functional response machine learning embeddings to determine similarity metrics for pairs of embeddings. Moreover, in one or more embodiments, the map fusion system generates a fused machine learning map of biology by using late fusion to combine the plurality of machine learning maps. Furthermore, in one or more embodiments, the map fusion system utilizes the fused machine learning map to determine one or more predicted biological relationships between one or more cell perturbation pairs.

To elaborate, in one or more embodiments, the map fusion system generates fused machine learning maps by aggregating biological information across different data types or model systems. For example, in some implementations, a first machine learning map includes biological data (e.g., similarity metrics of functional responses to cell perturbations) derived from a first model system or modality (e.g., a particular cell type exposed to the cell perturbations, a particular concentration of applied chemical compounds, and/or a particular data acquisition modality, such as cell painting or bright-field microscopy), while a second machine learning map includes biological data (e.g., similarity metrics of functional responses to the same set of cell perturbations) derived from a second model system or modality that is different from the first model system or modality (e.g., a different cell type exposed to the cell perturbations, a different concentration of applied chemical compounds, and/or a different data acquisition modality). The map fusion system can combine these two machine learning maps to provide enhanced biological data in a fused map that is supported by both input maps and that offers additional insights into the biological relationships between cell perturbations.

As another example, in some implementations, a first machine learning map includes biological data derived from a first biological modality (e.g., phenomics, transcriptomics, invivomics, etc.), while a second machine learning map includes biological data derived from a second biological modality that is different from the first biological modality. Still another example, in some implementations, a first machine learning map includes biological data derived from a first data layer (e.g., cell line data) while a second machine learning map includes biological data derived from a second data layer that is different from the first data layer (e.g., patient data).

Although the machine learning maps can have biological data of different sorts (from different model systems, different biological modalities, and/or different data layers), the map fusion system nonetheless can fuse the machine learning maps to enhance the biological information relating to cell perturbations. For example, the map fusion system logically and accurately combines this biological data to increase confidence of biological relationships represented in the machine learning maps, such as similarity metrics for various pairs of cell perturbations.

The map fusion system can utilize one or more of a variety of late fusion techniques to fuse multiple maps of biology, as described in further detail below. For example, the map fusion system can combine similarity metrics from a set of input maps according to weights associated with the input maps. As another example, the map fusion system can generate network graphs from the input maps and combine the network graphs into a fused graph. For instance, the map fusion system can use similarity network fusion to combine the network graphs. Moreover, in some implementations, the map fusion system combines the embeddings underlying the similarity metrics and then determines fused similarity metrics from the combined embeddings. Furthermore, the map fusion system can use a graph attention neural network to combine network graphs into a fused graph.

As mentioned, in one or more embodiments, the map fusion system utilizes late fusion to fuse two or more machine learning maps of biology. Moreover, the map fusion system can fuse the maps of biology without retraining or finetuning the foundation models (e.g., the source models of the underlying biological embeddings). In this way, the map fusion system can provide a flexible and accurate approach to aggregating multiple biological maps without requiring updates or changes to the underlying machine learning models used to generate biological embeddings.

Furthermore, by providing aggregated biological data from multiple sorts of model systems, modalities, and/or data layers, the map fusion system provides insights that help to improve knowledge of gene-gene relationships for causal target identification and/or biomarker discovery, and to improve knowledge of gene-compound relationships for pharmaceutical compound discovery. Indeed, understanding cellular responses to perturbations, and in particular understanding biological relationships across different types of perturbations, can be a complex part of pharmaceutical compound discovery. As described in additional detail below, the map fusion system offers a comprehensive view of these biological relationships to facilitate identifying drug targets.

For example, the map fusion system provides insight into complex cellular interactions by analyzing data from multiple biological modalities. For instance, the map fusion system can analyze data from various-omics approaches, including transcriptomics (e.g., measuring gene expression levels), phenomics (e.g., observing image phenotypic traits), and proteomics (e.g., studying protein structures and functions). While each of these modalities capture unique aspects of cellular behavior that provide a partial view of a larger biological picture, the map fusion system can combine these perspectives to reveal previously unseen biological connections, thereby accelerating drug discovery.

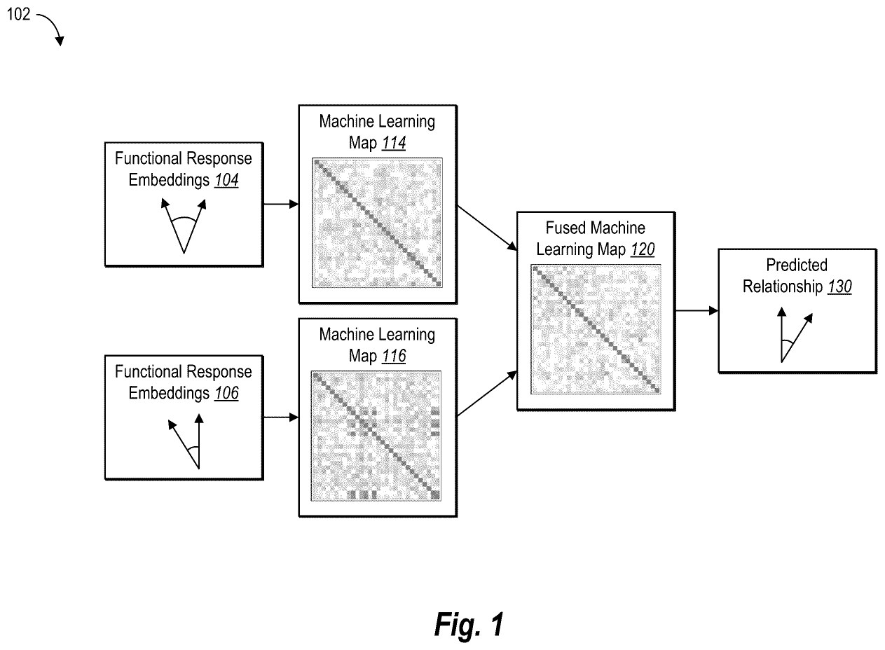

As mentioned, in some embodiments, the map fusion system generates and utilizes fused machine learning maps. For instance, FIG. 1 illustrates a map fusion system 102 generating a fused machine learning map by combining machine learning maps in accordance with one or more embodiments.

Specifically, FIG. 1 shows the map fusion system 102 accessing a first set of functional response machine learning embeddings 104. The functional response machine learning embeddings 104 each represent a functional response of a cell perturbation. A cell perturbation includes a modification or treatment applied to a biological cell, such as by a chemical compound perturbation (e.g., a drug treatment) or a gene knockout perturbation. For example, a cell perturbation can include a gene, small molecule (e.g., therapeutic compound or drug), biologic, or other treatment. In some embodiments, the map fusion system 102 generates the functional response machine learning embeddings (e.g., using a specialized encoder neural network for embedding cell perturbation effects), while in some embodiments, the map fusion system 102 obtains the functional response machine learning embeddings from another system.

As further shown in FIG. 1, in one or more embodiments, the map fusion system 102 utilizes the first set of functional response machine learning embeddings 104 to generate a first machine learning map 114 comprising a first set of machine learning similarity metrics between cell perturbations. To illustrate, the map fusion system 102 generates the first machine learning map 114 by comparing the various embeddings within the first set of functional response machine learning embeddings 104. For instance, the map fusion system 102 utilizes a metric (e.g., cosine similarity, Euclidean distance, or another similarity metric) to determine similarity scores for each functional response embedding as compared with each other functional response embedding. For example, the map fusion system 102 generates a matrix (or some other format of storing and representing similarity metrics) of similarity scores for the set of functional response machine learning embeddings 104. A machine learning map includes a map of biology that stores similarity metrics for pairs of functional response embeddings, whether in the form of a matrix, table, graph, vector, or other format.

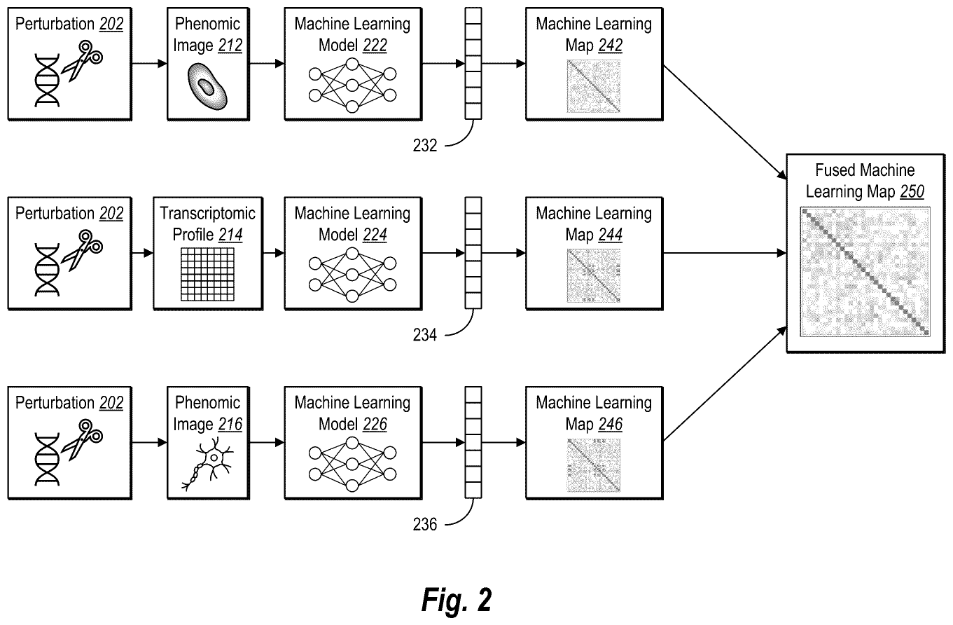

Similarly, in one or more embodiments, the map fusion system 102 accesses a second set of functional response machine learning embeddings 106. For instance, in some embodiments, the second set of functional response machine learning embeddings 106 represents functional responses of the same set of cell perturbations as those represented by the first set of functional response machine learning embeddings 104, but via a different model system, biological modality, or data layer. For example, the first set of functional response machine learning embeddings 104 may be in a phenomic embedding space (or some other-omic embedding space), while the second set of functional response machine learning embeddings 106 may be in a transcriptomic embedding space (or some other-omic embedding space). Other differences (e.g., in model system, biological modality, and/or data layer) between the first and second sets of functional response machine learning embeddings 104, 106 are contemplated by this disclosure, as described in additional detail below in connection with FIG. 2. In some cases, the set of cell perturbations represented by the second set of functional response machine learning embeddings 106 has only partial overlap with the set of cell perturbations represented by the first set of functional response machine learning embeddings 104 (e.g., one or both sets include cell perturbations not found in the other set).

Moreover, in one or more embodiments, the map fusion system 102 utilizes the second set of functional response machine learning embeddings 106 to generate a second machine learning map 116 comprising a second set of machine learning similarity metrics between the cell perturbations. For example, the map fusion system 102 generates the second machine learning map 116 by comparing the various embeddings within the second set of functional response machine learning embeddings 106, similar to generating the similarity metrics for the first machine learning map 114 as described above. For instance, in one or more embodiments, the second machine learning map 116 is a matrix of similarity metrics indicating similarities of the various functional response machine learning embeddings 106 with each other.

As further shown in FIG. 1, in some implementations, the map fusion system 102 generates a fused machine learning map 120 by using late fusion to combine the first machine learning map 114 and the second machine learning map 116. To illustrate, the map fusion system 102 applies one or more late fusion techniques to generate the fused machine learning map 120. For example, the map fusion system 102 generates the fused machine learning map 120 by determining enhanced similarity metrics corresponding to functional responses for the various cell perturbations. In some implementations, the fused machine learning map 120 is larger than one or both of the first and second machine learning maps 114, 116 (e.g., to include similarity metrics for cell perturbations that are not represented by both input maps).

Furthermore, in one or more embodiments, the map fusion system 102 utilizes the fused machine learning map 120 to determine a predicted relationship 130 between a first cell perturbation and a second cell perturbation of the set of cell perturbations. For instance, the map fusion system 102 determines the predicted relationship of the first cell perturbation as compared with the second cell perturbation based on an enhanced similarity metric stored in the fused machine learning map 120 for the two perturbations. The predicted relationship 130 can then be used in a downstream task. For example, the map fusion system 102 can use the predicted relationship 130 to generate one or more additional predictions, or can coordinate with another system to initiate or advance one or more programs of drug discovery.

As mentioned, existing systems have a number of technical problems with regard to accuracy and operational flexibility of implementing computing devices. For example, existing systems are often inaccurate and inflexible in that they do not provide a way of aggregating similarity metrics for cell perturbations from diverse types of biological data. For instance, existing systems generally cannot combine machine learning maps. Thus, existing systems lack capabilities to provide an accurate and comprehensive view of the relationships between cell perturbations as informed by multiple biological modalities, model systems, or data layers.

The map fusion system 102 provides a variety of technical advantages relative to existing systems. For example, the map fusion system 102 provides new approaches for aggregating biological data from systems with diverse experimental modalities. For instance, the map fusion system 102 can fuse maps of biology without retraining or finetuning the foundation machine learning models used to generate the underlying embeddings for the maps of biology. Thus, the map fusion system 102 can improve functional performance while maintaining efficiency by avoiding extensive re-training of underlying foundational machine learning models. Moreover, the map fusion system 102 improves the drug discovery process by enhancing similarity metrics for perturbation pairs that are used to identify perturbations to investigate in a downstream drug discovery task.

Moreover, the map fusion system 102 transforms and improves biological data by logically combining machine learning maps of biology to increase the confidence of biological relationships represented in the machine learning maps. Indeed, the map fusion system 102 can strengthen known relationships and remove false relationships when generating the enhanced similarity metrics of the fused machine learning map. Furthermore, the map fusion system 102 improves machine learning processes by generating new information (the enhanced similarity metrics in the fused machine learning maps) previously unavailable for tech-bio discovery processes. For example, the map fusion system 102 can utilize fused maps for intelligent program initiation, compound exploration to refine compounds to more particularly interact with a treatment target, as part of pre-clinical trials, as part of patient refinement in clinical trials, and to develop and provide therapeutic compounds to patients.

As mentioned, in some embodiments, the map fusion system 102 generates fused machine learning maps of biological relationships across various combinations of biological modalities, data layers, or model systems. For instance, the map fusion system 102 fuses maps of biology across various-omic modalities for measuring biological information. As another example, the map fusion system 102 fuses maps of biology across various model systems for different cell types (e.g., HUVECs, nerve cells, etc.) exposed to cell perturbations. Additionally, the map fusion system 102 can fuse maps of biology across other model systems, including different data acquisition modalities (e.g., cell painting image capture and bright-field image capture). To illustrate, FIG. 2 shows the map fusion system 102 generating a fused machine learning map across multiple biological model systems, biological modalities, and/or cell lines in accordance with one or more embodiments.

Specifically, FIG. 2 shows the map fusion system 102 generating a fused machine learning map 250 across phenomics and transcriptomics modalities. For example, the map fusion system 102 applies a cell perturbation 202 to a cell and captures a digital image 212 of the cell exposed to the perturbation 202. In addition, in some implementations, the map fusion system 102 utilizes a machine learning model 222 to generate a phenomic embedding 232 for the digital image 212. In some embodiments, the map fusion system 102 generates the phenomic embedding 232 utilizing techniques described in UTILIZING MACHINE LEARNING MODELS TO SYNTHESIZE PERTURBATION DATA TO GENERATE PERTURBATION HEATMAP GRAPHICAL USER INTERFACES, U.S. patent application Ser. No. 18/526,707, filed on Dec. 1, 2023; UTILIZING MASKED AUTOENCODER GENERATIVE MODELS TO EXTRACT MICROSCOPY REPRESENTATION AUTOENCODER EMBEDDINGS, U.S. patent application Ser. No. 18/545,399, filed on Dec. 19, 2023; or UTILIZING MASKED AUTOENCODER GENERATIVE MODELS TO EXTRACT CELLULAR RESPONSE REPRESENTATION EMBEDDINGS, U.S. patent application Ser. No. 19/074,095, which are incorporated by reference herein in their entirety.

The phenomic embedding 232 represents a functional response of the cell to the cell perturbation 202. For example, the phenomic embedding 232 is a vector representation in a phenomic feature space. Furthermore, the map fusion system 102 uses the phenomic embedding 232 to populate a machine learning map 242. For example, the map fusion system 102 compares the phenomic embedding 232 with another phenomic embedding (e.g., representing a functional response of a cell exposed to a different cell perturbation) to generate a similarity metric, which the map fusion system 102 adds to the machine learning map 242.

Alternatively, in some embodiments, another system applies the cell perturbation 202 to the cell and communicates results of a functional response with the map fusion system 102. For example, the other system generates the phenomic embedding 232 (e.g., using the machine learning model 222) and transmits the phenomic embedding 232 to the map fusion system 102. With a set of phenomic embeddings representing functional responses of cells exposed to cell perturbations, the map fusion system 102 can generate similarity metrics for perturbation pairs and populate the machine learning map 242.

A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer neural network, or a generative adversarial neural network.

In addition to generating the machine learning map 242 based on phenomic data for a first cell type, FIG. 2 shows the map fusion system 102 generating a machine learning map 244 based on transcriptomic data (e.g., for the first cell type or for a different cell type). To illustrate, the map fusion system 102 applies the cell perturbation 202 to a cell and determines a transcriptomic profile 214 (e.g., count of expressed RNAs) of the cell exposed to the perturbation 202. For example, the map fusion system 102 utilizes a next-generation sequencing platform to determine the number of mRNAs (or other transcription molecules). The map fusion system can generate the transcriptomic profile 214 by combining counts of individual mRNAs (expressed across the genome) into a data structure such as an array or matrix. In addition, the map fusion system 102 utilizes a machine learning model 224 to generate a transcriptomic embedding 234 for the transcriptomic profile 214. In some embodiments, the map fusion system 102 utilizes a variety of different machine learning models or architectures for the machine learning model 224, including, but not limited to, scVI, Geneformer, scGPT, CellPLM, Universal Cell Embeddings or “UCE,” scBERT, and/or scVAEIT.

The transcriptomic embedding 234 represents a functional response of the cell to the cell perturbation 202. For example, the transcriptomic embedding 234 is a vector representation in a transcriptomic feature space. Furthermore, the map fusion system 102 uses the transcriptomic embedding 234 to populate the machine learning map 244. For example, the map fusion system 102 compares the transcriptomic embedding 234 with another transcriptomic embedding (e.g., representing a functional response of a cell exposed to a different cell perturbation) to generate a similarity metric, which the map fusion system 102 adds to the machine learning map 244.

Alternatively, in some embodiments, another system applies the cell perturbation 202 to the cell and communicates results of a functional response with the map fusion system 102. For example, the other system generates the transcriptomic embedding 234 (e.g., using the machine learning model 224) and transmits the transcriptomic embedding 234 to the map fusion system 102. With a set of transcriptomic embeddings representing functional responses of cells exposed to cell perturbations, the map fusion system 102 can generate similarity metrics for perturbation pairs and populate the machine learning map 244.

Additionally, or alternatively, as shown in FIG. 2, the map fusion system 102 can generate a machine learning map 246 based on phenomic data for a second cell type (different from the first cell type, such as HUVEC or neuronal cells). For instance, the map fusion system 102 applies a cell perturbation 202 to a cell of the second cell type and captures a digital image 216 of the cell exposed to the perturbation 202. In addition, the map fusion system 102 utilizes a machine learning model 226 to generate a phenomic embedding 236 for the digital image 216. The phenomic embedding 236 represents a functional response of the cell exposed to the cell perturbation 202. Furthermore, the map fusion system 102 uses the phenomic embedding 236 to populate the machine learning map 246. For example, the map fusion system 102 compares the phenomic embedding 236 with another phenomic embedding (e.g., representing a functional response of a cell exposed to a different cell perturbation) to generate a similarity metric, which the map fusion system 102 adds to the machine learning map 246.

As noted above, other lines of cell experimentation, other biological modalities, other data layers, and/or other model systems can be used and represented in the machine learning maps. The examples shown in FIG. 2 (the machine learning map 242 for phenomic similarity metrics for a first cell type, the machine learning map 244 for transcriptomic similarity metrics, and the machine learning map 246 for phenomic similarity metrics for a second cell type) are merely exemplary and nonlimiting for the present disclosure. Moreover, various numbers of input machine learning maps are contemplated by this disclosure. For example, while FIG. 1 shows the map fusion system 102 generating a fused machine learning map from two input machine learning maps, and while FIG. 2 shows the map fusion system 102 generating a fused machine learning map from three input machine learning maps, the map fusion system 102 can generate fused maps from four, five, or more input maps of biology.

Moreover, in some embodiments, the map fusion system 102 fuses multiple machine learning maps generated by the same machine learning model but utilizing different underlying datasets. For example, the map fusion system 102 utilizes the same phenomic machine learning model (e.g., the machine learning model 222) to generate two machine learning maps: one based on phenomic data from a first cell line, and another based on phenomic data from a second (different) cell line. The map fusion system 102 can fuse these maps into one fused machine learning map that transforms the underlying phenomic data to capture phenomic information from both input maps.

Furthermore, in some embodiments, the map fusion system 102 fuses multiple machine learning maps generated by different machine learning models but utilizing the same underlying dataset. For instance, the map fusion system 102 utilizes a first machine learning model (e.g., the machine learning model 222) to generate a first machine learning map based on phenomic data from a cell line; and utilizes a second machine learning model (e.g., the machine learning model 226) to generate a second machine learning map based on the same phenomic data from the same cell line. The map fusion system 102 can fuse these maps into one fused machine learning map that transforms the underlying phenomic data to capture phenomic information from both input maps.

In addition, in one or more embodiments, the map fusion system 102 fuses machine learning maps comprising information for non-perturbation data (e.g., with machine learning maps comprising perturbation data and/or with other maps comprising non-perturbation data). For instance, the map fusion system 102 utilizes a machine learning model to generate machine learning embeddings of non-perturbation data, such as chemical compound structures and/or gene relationships (e.g., expression information, sequence information, etc.). The map fusion system 102 can determine similarity metrics for the non-perturbation data. For example, the map fusion system 102 compares machine learning embeddings of compound structures to determine compound similarity metrics. As another example, the map fusion system 102 compares machine learning embeddings of gene information to determine gene similarity metrics. The map fusion system 102 can generate a machine learning map comprising the non-perturbation similarity metrics.

Moreover, the map fusion system 102 can fuse multiple machine learning maps comprising non-perturbation similarity metrics. For example, the map fusion system 102 fuses a map of compound similarity metrics with a map of gene similarity metrics. Furthermore, the map fusion system 102 can fuse a non-perturbation map with a perturbation map. For instance, the map fusion system 102 fuses a map of (non-perturbation) compound similarity metrics with a map of machine learning similarity metrics derived from compound perturbations applied to cells. In this way, the map fusion system 102 can enhance biological data whether such data was derived from applying cell perturbations to cells or derived from some other mechanism or analysis of biological information.

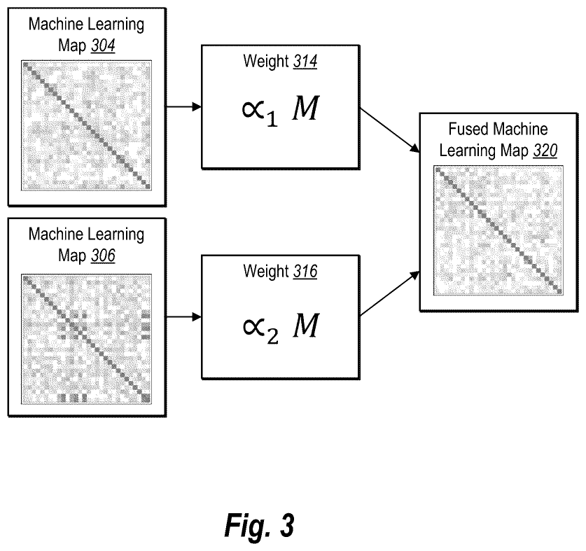

As mentioned, in some embodiments, the map fusion system 102 applies weights to various input machine learning maps to generate a fused machine learning map. For instance, FIG. 3 illustrates the map fusion system 102 generating a fused machine learning map from a weighted combination of input machine learning maps in accordance with one or more embodiments.

Specifically, FIG. 3 shows the map fusion system 102 combining a first machine learning map 304 with a second machine learning map 306 according to weights associated with the first machine learning map 304 and the second machine learning map 306 to generate a fused machine learning map 320. For example, the map fusion system 102 combines a first set of machine learning similarity metrics (as stored in the first machine learning map 304) with a second set of machine learning similarity metrics (as stored in the second machine learning map 306) according to a weighted average determined by a first weight 314 and a second weight 316 to generate the fused machine learning map 320.

For example, in one or more embodiments, the map fusion system 102 determines the first and second weights 314, 316 based on benchmark measures for the respective foundation models. For instance, the map fusion system 102 compares a sample similarity metric from the machine learning map 304 with a known bioactivity result for the corresponding perturbations to determine a first benchmark measure for a first machine learning model underlying the first machine learning map 304. Similarly, the map fusion system 102 compares a sample similarity metric from the machine learning map 306 with a known bioactivity result for the corresponding perturbations to determine a second benchmark measure for a second machine learning model underlying the second machine learning map 306.

In some implementations, the map fusion system 102 determines the first and second benchmark measures based on multiple comparisons of sample similarity metrics with known bioactivity results to determine an accuracy level for the underlying machine learning models (e.g., a percentage of sample similarity metrics that meet a threshold level of accuracy). Moreover, in one or more embodiments, the map fusion system 102 applies the first and second benchmark measures to the first and second machine learning maps 304, 306 (e.g., as weighting multipliers) to fuse the maps into the fused machine learning map 320.

As another example, in one or more embodiments, the map fusion system 102 determines the first and second weights 314, 316 based on rates of statistical significance of the embeddings that underlie the first and second machine learning maps 304, 306. For instance, the map fusion system 102 can sample the underlying functional response embeddings to determine measures of statistical significance of the embeddings. For example, the map fusion system 102 can compare a plurality of embeddings corresponding to a perturbation with a null distribution (e.g., relative to a distribution of random perturbation embeddings) to determine whether the plurality of embeddings satisfy a threshold statistical significance for embeddings for that perturbation. Moreover, the map fusion system 102 can determine measures of statistical significance for multiple (e.g., many) pluralities of embeddings corresponding to multiple perturbations to determine a rate of statistical significance for the underlying machine learning model. For instance, in some implementations, the map fusion system 102 determines phenoprint rates for machine learning models as described in TRAINING AND UTILIZING MACHINE LEARNING MODELS TO GENERATE PERTURBATION EMBEDDINGS FROM PHENOMIC IMAGES OF CELLS, INCLUDING NEURONAL CELL IMAGES, U.S. patent application Ser. No. 19/174,414, filed Apr. 9, 2025, which is incorporated by reference herein in its entirety.

Furthermore, the map fusion system 102 can determine rates of statistical significance for each underlying machine learning model (e.g., for each input machine learning map) and compare these rates to determine the weights 314, 316. For example, if the rate of statistical significance for the first machine learning model is higher than the rate of statistical significance for the second machine learning model, the map fusion system 102 assigns a larger weight for the first machine learning map 304 relative to the weight for the second machine learning map 306.

The map fusion system 102 can also select weights based on other factors. For example, the map fusion system 102 can select the weights 314, 316 based on the amount, type resolution, or quality of data (or training data) utilized by the machine learning models to generate the machine learning maps 304, 306. For instance, the map fusion system 102 can weight models that analyze higher-resolution phenomic images differently than models that analyze lower-resolution phenomic images. Similarly, the map fusion system 102 can select the weights 314, 316 based on the type of information utilized to generate the machine learning maps 304, 306. For example, the map fusion system 102 can weight a phenomic map more heavily than another-omics map (e.g., if phenomic similarity is important for a use case of the fused machine learning map 320). Similarly, the map fusion system 102 can weight a particular cell type more heavily (e.g., if the fused machine leaning map 320 is used in an application more pertinent to that cell type). Thus, the weights 314, 316 can depend on a correspondence between the underlying data or model and the purpose or application of the fused machine learning map 320.

In one or more embodiments, the map fusion system 102 updates (e.g., tunes) the weights 314, 316 according to a measure of accuracy of the fused machine learning map 320. For example, the map fusion system 102 compares a sample of enhanced similarity metrics in the fused machine learning map 320 with known similarity metrics and updates the first and second weights 314, 316 to generate a more accurate fused machine learning map 320 on a subsequent tuning iteration.

In some implementations, the map fusion system 102 can also select weights in an iterative process by testing and analyzing the resulting fusion map 320. For example, the map fusion system 102 can determine a benchmarking measure and/or statistical significance rate for the fused machine learning map 320, revise the weights 314, 316 and determine updated benchmarking measures and/or statistical significance rates. In this manner, the map fusion system 102 can iteratively modify the weights 314, 316 based on iterative different of the fused machine learning map 320.

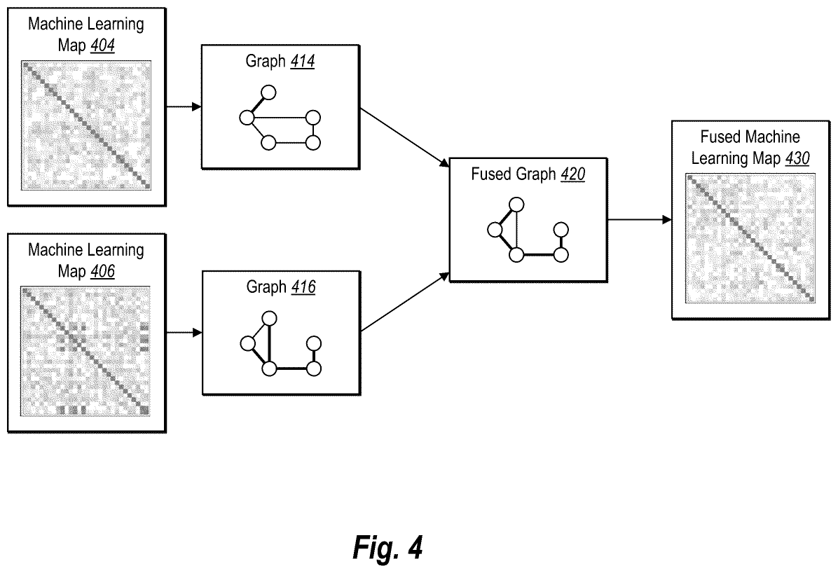

As discussed above, in one or more embodiments, the map fusion system 102 utilizes network graphs to generate a fused machine learning map. For instance, FIG. 4 illustrates the map fusion system 102 generating a fused machine learning map by generating network graphs and fusing the network graphs in accordance with one or more embodiments.

Specifically, FIG. 4 shows the map fusion system 102 generating a first network graph 414 (or first graph 414) from a first machine learning map 404. For example, the first graph 414 has nodes corresponding to cell perturbations (e.g., a node to represent each perturbation) and edge weights between the nodes representing similarity metrics for the cell perturbations. For instance, a first edge weight between a first pair of nodes represents a similarity metric for a first corresponding pair of perturbations, while a second edge weight between a second pair of nodes represents a similarity metric for a second corresponding pair of perturbations. For example, a large edge weight indicates a high degree of similarity between the perturbations represented by the nodes linked by the large edge weight. A network graph, or graph, includes a network of nodes and edges that stores biological information for cell perturbations. For example, a graph has nodes that represent cell perturbations. Moreover, a graph has edges between pairs of nodes, where the edges have edge weights that represent similarities of functional responses of the corresponding cell perturbations represented by the nodes. In particular, a larger edge weight between nodes represents a stronger similarity of functional responses.

Moreover, as shown in FIG. 4, the map fusion system 102 generates a second network graph 416 (or second graph 416) from a second machine learning map 406. Similar to the first graph 414, the second graph 416 has nodes corresponding to cell perturbations and edge weights between the nodes representing similarity metrics for the cell perturbations. In some embodiments, the nodes of the second graph 416 are identical to the nodes of the first graph 414, as both sets of nodes can represent the same set of cell perturbations. However, in various embodiments, the edge weights of the second graph 416 are different from the edge weights of the first graph 414, as the represented similarity metrics can be different (e.g., due to differences in model systems, cell types, biological modalities, etc.).

As mentioned, in one or more embodiments, the map fusion system 102 fuses the first graph 414 and the second graph 416 to generate a fused graph 420. For example, the map fusion system 102 combines the first graph 414 and the second graph 416 to generate the fused graph 420. To illustrate, the fused graph 420 has nodes corresponding to cell perturbations and edge weights between the nodes representing similarity metrics for the cell perturbations. For example, in some embodiments, the nodes of the fused graph 420 match the nodes of the first graph 414 and the second graph 416 to represent the cell perturbations.

Moreover, the edge weights of the fused graph 420 can be different from both the edge weights of the first graph 414 and the edge weights of the second graph 416. For instance, the edge weights of the fused graph 420 represent a fused set of similarity metrics between a set of pairs of the cell perturbations. For example, the edge weights between the nodes of the fused graph 420 represent fused similarity metrics based on information contained in the edge weights of the first and second graphs 414, 416. For instance, the map fusion system 102 strengthens those edge weights that correspond with strong edge weights in the input graphs, and reduces those edge weights that correspond with weak edge weights in the input graphs.

Furthermore, as shown in FIG. 4, in one or more embodiments, the map fusion system 102 utilizes the fused graph 420 to generate a fused machine learning map 430. For example, in some embodiments, the map fusion system 102 utilizes the nodes and edge weights of the fused graph 420 to populate a matrix of similarity metrics for the cell perturbations. In some implementations, the map fusion system 102 generates the fused machine learning map 430 as a visual illustration or heat map. Thus, the map fusion system 102 can provide (e.g., for display via a graphical user interface of a client device) a visual depiction of biological similarities of cell perturbations via the fused machine learning map 430. In particular, rows and columns can represent different perturbations and cells of a heatmap can visually indicate different similarity metrics between the intersecting perturbations.

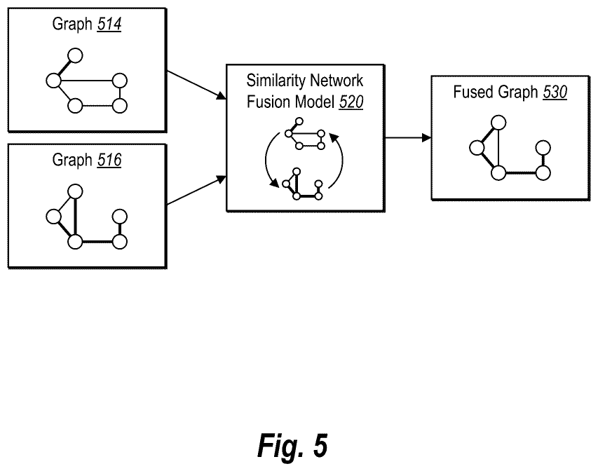

As mentioned, in one or more embodiments, the map fusion system 102 utilizes similarity network fusion to generate a fused graph for a set of cell perturbations. For instance, FIG. 5 illustrates the map fusion system 102 utilizing a similarity network fusion model to generate a fused graph in accordance with one or more embodiments.

Specifically, FIG. 5 shows the map fusion system 102 accessing a first graph 514 and a second graph 516. For example, the map fusion system 102 generates the first graph 514 and the second graph 516 as discussed above. Moreover, in one or more embodiments, the map fusion system 102 utilizes a similarity network fusion model 520 to generate a fused graph 530 from the first graph 514 and the second graph 516. For instance, the map fusion system 102 utilizes the similarity network fusion model 520 to iteratively update a set of edge weights of the fused graph 530 based on the edge weights of the first and second graphs 514, 516.

To illustrate, in one or more embodiments, the map fusion system 102 utilizes the similarity network fusion model 520 to fuse the first graph 514 and the second graph 516 into a single integrated network of similarity metrics. Similarity network fusion includes techniques for integrating multiple network graphs into a single network graph by combining information to maximize (or increase) common structure shared across the multiple graphs. For example, similarity network fusion can amplify or reinforce shared structure across graphs while attenuating or eliminating divergent structure across the graphs.

For example, in some implementations, the map fusion system 102 updates the input graphs at each iteration step to converge the graphs into a common graph (such that the updated input graphs become the same graph). For example, the map fusion system 102 generates an updated instance of the first graph 514 and an updated instance of the second graph 516, bringing an aggregate of all nodes and edge weights to be more closely aligned. The map fusion system 102 repeats this process until the first graph 514 and the second graph 516 converge into an identical graph, which the map fusion system 102 then stores as the fused graph 530. In one or more embodiments, the map fusion system 102 performs the similarity network fusion techniques described herein on one or more central processing units (CPUs). In one or more embodiments, the map fusion system 102 performs the similarity network fusion techniques described herein on one or more graphics processing units (GPUs). In some cases, the map fusion system 102 enhances computing efficiency by utilizing GPUs to perform iterations of a similarity network fusion model.

To elaborate, in one or more embodiments, the map fusion system 102 generates similarity matrices for each input graph 514, 516. These similarity matrices represent pairwise similarities between nodes (e.g., based on the edge weights). Moreover, the map fusion system 102 iteratively aggregates these similarity matrices into a fused matrix that highlights relationships across each input graph while preserving important information from individual graphs. To illustrate, the map fusion system 102 can determine element-wise combinations by a weighted average (e.g., using weights as described in connection with FIG. 3). In some implementations, the map fusion system 102 normalizes the fused matrix during each iteration to ensure consistency across iterations.

After the first iteration, the map fusion system 102 refines the first instance of the fused matrix by combining it with the original similarity matrices. In subsequent iterations, the map fusion system 102 compares an updated instance of the fused matrix with the previous instance of the fused matrix to check for convergence. For example, the map fusion system 102 determines a norm of a difference between the two instances of the fused matrix and compares the norm with a predetermined threshold value. If the norm satisfies the predetermined threshold value, the map fusion system 102 determines that fusion is complete and generates the fused graph 530 from the final instance of the fused matrix. For example, the map fusion system 102 determines edge weights for the fused graph 530 from the elements of the final fused matrix. For example, in some implementations, the map fusion system 102 utilizes a similarity fusion network as described by Bo Wang, et al. in Similarity Network Fusion For Aggregating Data Types On A Genomic Scale, Nature Methods 11, 333-337 (2014), which is incorporated by reference in its entirety herein.

As with fusing machine learning maps described above, the map fusion system 102 can use the similarity network fusion model 520 to fuse more than two graphs. For example, the map fusion system 102 can fuse three, four, or more graphs into a fused graph. Thus, the illustration of FIG. 5 of two input graphs to generate a fused graph is not to be construed as limiting this disclosure.

Alternatively, in some implementations, the map fusion system 102 iteratively updates the fused graph 530 during the similarity network fusion process. For example, the map fusion system 102 utilizes the similarity network fusion model 520 to generate a first instance of the fused graph 530. Then, the map fusion system 102 utilizes the similarity network fusion model 520 to generate a second, updated instance of the fused graph 530. Subsequently, the map fusion system 102 utilizes the similarity network fusion model 520 to generate a third, again-updated instance of the fused graph 530. The map fusion system 102 can follow this iterative process until the fused graph 530 meets a stopping criterion, such as a threshold level of accuracy as determined by comparing the fused graph 530 to the first graph 514 and the second graph 516. For instance, the map fusion system 102 can stop the iterative process when a weighted difference function of the fused graph 530 against the first graph 514 and the second graph 516 converges to a steady state. Thus, in one or more embodiments, the map fusion system 102 iteratively updates the fused graph 530 by adjusting the edge weights in the fused graph 530 at each step to increase the similarity of the fused graph 530 with the input graphs.

Upon generating the fused graph 530 (e.g., the final instance of the fused graph 530), the map fusion system 102 can utilize the fused graph 530 in a downstream task, such as identifying one or more perturbations for further investigation or to initiate an industrial program for compound discovery. For example, the map fusion system 102 can utilize the fused graph 530 to determine perturbation similarities for utilization with a program initiation model. Indeed, similarity measures from the fused graph 530 can be utilized with a large language machine learning model to generate program initiation predictions as described in UTILIZING BIOLOGICAL MACHINE LEARNING REPRESENTATIONS AND A LANGUAGE MACHINE LEARNING MODEL FOR INITIATING COMPOUND EXPLORATION PROGRAMS, U.S. patent application Ser. No. 18/521,910, filed on Nov. 28, 2023, which is incorporated by reference in its entirety herein.

In some embodiments, the map fusion system 102 can utilize the fused graph as part of other downstream drug discovery processes such as an industrial program generation (IPG) process. To illustrate, IPG includes a hit selection to identify statistically strong connections; map confirmation; automated similarity and concentration-response analytics; and Structure-Activity Relationship (SAR) confidence. In other words, the map fusion system 102 can utilize the fused graph 530 to initiate and/or execute an IPG process for exploring compounds for therapeutic treatment.

Moreover, in some embodiments the map fusion system 102 utilizes the fused graph 530 as part of an industrialized compound generation (ICG) process. For instance, ICG applies to steps subsequent to IPG. Further, in some embodiments ICG includes rapidly searching and expanding from potential hit series in the chemical space (e.g., identified at the IPG stage) and testing the potential hits with various analytical tests (e.g., SAR screens). The map fusion system 102 can also optimize identified compounds and analyze results of the compounds applied to the specific target.

Moreover, the map fusion system 102 can also utilize the fused graph 530 as part of additional drug discovery processes. In some instances, the map fusion system 102 utilizes the fused graph 530 as part of pre-clinical testing, clinical trials (e.g., identifying and providing drugs to particular patient populations), candidate selection for further testing, and regulatory approval.

Moreover, in some embodiments, the map fusion system 102 generates a fused machine learning map from the fused graph 530 (e.g., as described above in connection with FIG. 4). For example, the map fusion system 102 converts the similarity information stored in the fused graph 530 into a different format, such as a matrix of similarity metrics.

As mentioned, the map fusion system 102 can employ one or more of a variety of late fusion techniques to fuse machine learning maps together. As another example fusion technique, in one or more embodiments, the map fusion system 102 can combine embeddings from multiple biological model systems, biological modalities, and/or cell lines and generate similarity metrics from the combined embeddings.

For example, the map fusion system 102 can generate a set of combined functional response machine learning embeddings by combining a first set of functional response machine learning embeddings (e.g., from a phenomics machine learning model or representing a first cell line) and a second set of functional response machine learning embeddings (e.g., from a transcriptomics machine learning model or representing a second cell line). For instance, the map fusion system 102 performs perturbation-wise combinations of the functional response machine learning embeddings.

For example, for a first perturbation, the map fusion system 102 combines (e.g., normalizes and concatenates, adds, multiplies, etc.) a corresponding embedding from the first set of functional response machine learning embeddings with a corresponding embedding from the second set of functional response machine learning embeddings to generate a first combined functional response embedding. Similarly, for a second perturbation, the map fusion system 102 combines (e.g., normalizes and concatenates, adds, multiplies, etc.) a corresponding embedding from the first set of functional response machine learning embeddings with a corresponding embedding from the second set of functional response machine learning embeddings to generate a second combined functional response embedding.

With the combined embeddings, the map fusion system 102 can generate similarity metrics. For example, the map fusion system 102 compares the first and second combined functional response embeddings to generate a fused machine learning similarity metric that represents a similarity between the first perturbation and the second perturbation. The map fusion system 102 can repeat this process for all perturbations represented by the first and second sets of functional response machine learning embeddings. With the fused machine learning similarity metrics, the map fusion system 102 can generate a fused machine learning map that represents aggregated similarity information from all types of biological model systems, biological modalities, and/or cell lines that produced the underlying biological data.

Moreover, as another example late fusion technique, in one or more embodiments, the map fusion system 102 utilizes a graph attention network to generate a fused graph for a set of cell perturbations. For instance, the map fusion system 102 can utilize a graph attention neural network to generate a fused graph from multiple input graphs of biological similarities. For example, the graph attention neural network can be a graph convolutional network with an attention mechanism that focuses on edge weights of the input graphs to determine new edge weights for a fused graph. For instance, the map fusion system 102 uses the graph attention neural network to focus on the strongest edge weights (representing the perturbation pairs with highest degree of similarity) and give those strong edge weights precedence when building the fused graph. The graph attention neural network can determine attention coefficients for the graph nodes based on the edge weights, from which the map fusion system 102 can aggregate the graphs by determining fused edge weights based on the edge weights from the input graphs, as weighted by the attention coefficients.

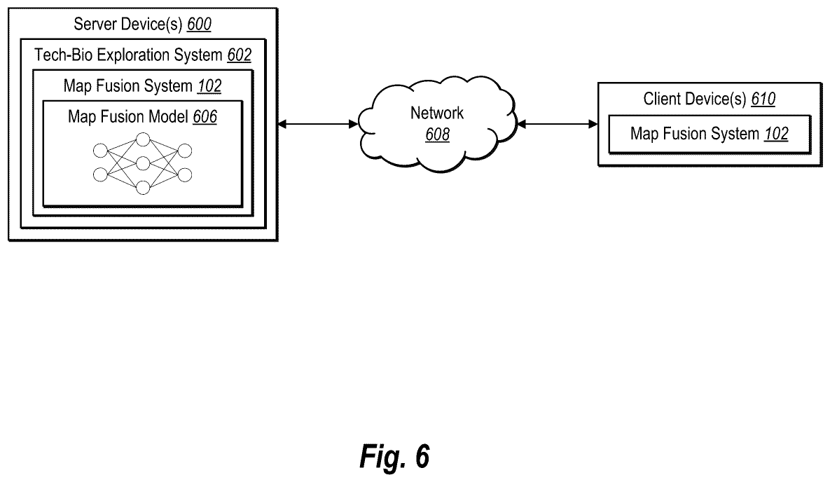

Additional detail regarding the computing environment in which the map fusion system 102 operates will now be provided with reference to FIG. 6. In particular, FIG. 6 illustrates a schematic diagram of a system environment in which the map fusion system 102 can operate in accordance with one or more embodiments.

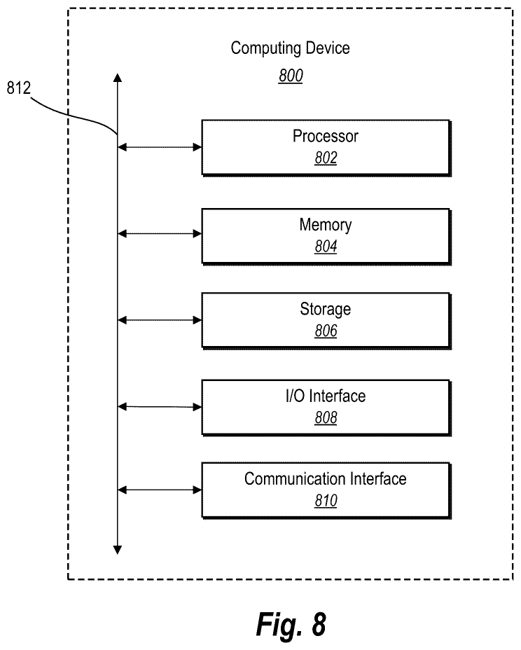

As shown in FIG. 6, the environment includes server device(s) 600 (which includes a tech-bio exploration system 602 and the map fusion system 102), client device(s) 610, and a network 608. As further illustrated in FIG. 6, the various computing devices within the environment can communicate via the network 608. Although FIG. 6 illustrates the map fusion system 102 being implemented by a particular component and/or device within the environment, the map fusion system 102 can be implemented—in whole or in part—by other computing devices and/or components in the environment (e.g., additional client device(s)). Additional description regarding the illustrated computing devices is provided with respect to FIG. 8 below.

As shown in FIG. 6, the server device(s) 600 (e.g., one or more local servers operated by a particular entity) can include the tech-bio exploration system 602. In some embodiments, the tech-bio exploration system 602 can determine, store, generate, and/or provide for display tech-bio information including experiments from various sources, machine learning tech-bio predictions, machine learning embeddings for biological cell perturbations, and/or machine learning maps of biology, among others. For instance, the tech-bio exploration system 602 can analyze data signals corresponding to various treatments or interventions (e.g., compounds or biologics) and the corresponding relationships in genetics, proteomics, phenomics (e.g., cellular phenotypes), transcriptomics (e.g., transcription expression counts), and invivomics (e.g., expressions or results within a living animal). Moreover, the tech-bio exploration system 602 provides an environment for operating, executing, and/or managing complex drug discovery pipelines.

For instance, the tech-bio exploration system 602 can generate and access experimental results corresponding to gene sequences, protein shapes/folding, protein/compound interactions, phenotypes resulting from various interventions or perturbations (e.g., gene knockout sequences or compound treatments), and/or in vivo experimentation on various treatments in living animals. By analyzing these signals (e.g., utilizing various machine learning models), the tech-bio exploration system 602 can generate or determine a variety of predictions and inter-relationships for improving treatments/interventions.

To illustrate, the tech-bio exploration system 602 can utilize machine learning models to enhance biological information captured in data samples as part of the complex compound discovery process. For instance, the tech-bio exploration system 602 can identify a similarity between a first gene associated with disease treatment and a second gene previously unassociated with the disease based on a similarity in resulting phenotypes from gene knockout experiments. The tech-bio exploration system 602 can then identify new treatments based on the gene similarity (e.g., by targeting compounds that impact the second gene). Similarly, the tech-bio exploration system 602 can analyze signals from a variety of sources (e.g., protein interactions, in vivo experiments) to predict efficacious treatments based on various levels of biological data.

The tech-bio exploration system 602 can generate GUIs comprising dynamic user interface elements to convey tech-bio information and receive user input for intelligently exploring tech-bio information. Indeed, the tech-bio exploration system 602 can generate GUIs to display biological information enhanced via the map fusion system 102 as described herein. Furthermore, the tech-bio exploration system 602 can also electronically communicate tech-bio information between various computing devices.

The tech-bio exploration system 602 can include a system that facilitates various models or algorithms for generating enhanced biological information and discovering new treatment options over one or more networks. For example, the tech-bio exploration system 602 collects, manages, and transmits data across a variety of different entities, accounts, and devices. In some cases, the tech-bio exploration system 602 is a network system that facilitates access to (and analysis of) tech-bio information within a centralized operating system. Indeed, the tech-bio exploration system 602 can link data from different network-based research institutions to generate and analyze enhanced biological information.

As shown in FIG. 6, the tech-bio exploration system 602 can include the map fusion system 102 that generates, stores, manages, and/or transmits data pertaining to biological information. For example, in the context of the above description for the tech-bio exploration system 602, in some embodiments, the tech-bio exploration system 602 further utilizes the map fusion system 102 to enhance the coordination between various groups involved in the drug discovery process. For instance, the map fusion system 102 works in tandem with the tech-bio exploration system 602 to generate fused maps of biology, transmit the fused maps of biology to one or more devices, and initiate one or more downstream model predictions or processes.

As also illustrated in FIG. 6, the environment includes the client device(s) 610. As mentioned above, the client device(s) 610 can be involved in the process of drug discovery. Thus, for example, the client device(s) 610 can coordinate/manage a first stage of generating enhanced biological information (e.g., one or more fused machine learning maps). Moreover, the client device(s) 610 can coordinate/manage a second stage such as generating a biological activity prediction (e.g., a predicted biological relationship) based on the enhanced biological information. Further, the client device(s) 610 can coordinate and/or manage a third stage of utilizing the biological activity prediction to generate one or more additional predictions or initiate one or more programs (e.g., industrial program generation (IPG) or industrialized compound generation (ICG)).

To illustrate, the client device(s) 610 can include computing devices that implement or manage a compound program generation stage of a compound discovery process. Similarly, the client device(s) 610 can include computing devices that implement or manage a compound lead generation stage and the client device(s) 610 can include computing devices that implement or manage a compound/dose selection stage. For example, the map fusion system 102 can receive one or more requests to utilize a map fusion model 606 (e.g., the similarity network fusion model 520) to generate one or more fused machine learning maps. Additionally, the map fusion system 102 can receive additional requests from the client device(s) 610 that include generating the biological activity predictions.

In some embodiments, the environment also includes additional device(s). For example, the map fusion system 102 can utilize the additional device(s) to further operate and manage the completion of complex drug discovery pipelines. For instance, the additional device(s) include experimental device(s) and analytical device(s). Further, in some instances, the additional device(s) also include the computing devices discussed below in connection with FIG. 8.

Furthermore, in one or more implementations, the client device(s) 610 include a client application. The client application can include instructions that (upon execution) cause the client device(s) 610 to perform various actions. For example, a user of a user account can interact with the client application on the client device(s) 610 to execute experiments or other multi-faceted processes, to further access tech-bio information, and/or initiate a request for a biological activity prediction. For instance, in some embodiments the map fusion system 102 receives a request to generate a fused machine learning map, and in response generates the fused machine learning map and returns the fused machine learning map to the client device(s) 610. In some instances, the transmittal of the fused machine learning map to the client device(s) 610 causes the client device(s) 610 to execute an action (e.g., generate a downstream model prediction or other task).

Additionally, the environment can include dedicated machine learning device(s). For example, the dedicated machine learning device(s) can include computing devices or virtual machines dedicated to training or implementing large-scale machine learning models. For example, the dedicated machine learning device(s) can generate machine learning predictions and/or embeddings based on digital biological data (e.g., digital images of phenotypes resulting from different perturbations or compound-protein interactions from compound features, transcriptomic profiles of transcription expression counts for different perturbations or compound-protein interactions, etc.). Thus, the map fusion system 102 can interact with the dedicated machine learning device(s) to generate biological embeddings.

The environment can also include experimental device(s). For example, the tech-bio exploration system 602 can interact with experimental device(s) that include intelligent robotic devices and camera devices for generating and capturing digital images of cellular phenotypes resulting from different perturbations (e.g., genetic knockouts or compound treatments of stem cells). Similarly, the experimental device(s) can include camera devices and/or other sensors (e.g., heat or motion sensors) capturing real-time information from animals as part of in vivo experimentation. The tech-bio exploration system 602 can also interact with a variety of other experimental device(s) such as devices for determining, generating, or extracting gene sequences or protein information. For example, the experimental device(s) may include computing devices linked to biosensors, electrophysiological platforms, x-ray crystallography machines, liquid chromatography-mass spectrometry systems, nuclear magnetic resonance spectrometers, and/or mass spectrometers. In some implementations, the map fusion system 102 generates biological embeddings, machine learning maps, and/or fused machine learning maps, and further determines to employ or utilize one or more experimental devices (e.g., to initiate one or more experiments based on similarity predictions).

As further shown in FIG. 6, the environment includes the network 608. As mentioned above, the network 608 can enable communication between components of the environment. In one or more embodiments, the network 608 may include a suitable network and may communicate using a various number of communication platforms and technologies suitable for transmitting data and/or communication signals, examples of which are described with reference to FIG. 8. Furthermore, although FIG. 6 illustrates computing devices communicating via the network 608, the various components of the environment can communicate and/or interact via other methods (e.g., communicate directly).

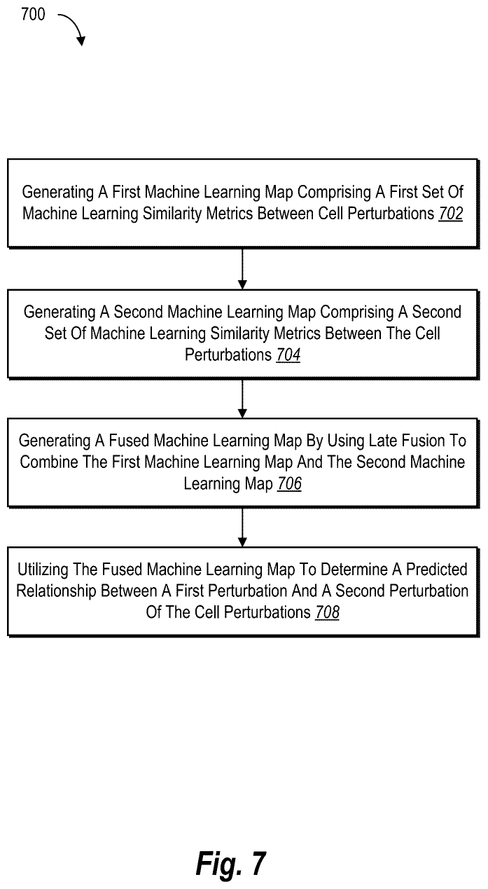

FIG. 1-6, the corresponding text, and the examples provide a number of different methods, systems, devices, and non-transitory computer-readable media of the map fusion system 102. In addition to the foregoing, one or more embodiments are described in terms of flowcharts comprising acts for accomplishing a particular result, as shown in FIG. 7. In some implementations, the processes of the map fusion system 102 are performed with more or fewer acts. Furthermore, in various implementations, the acts are performed in differing orders. Additionally, in some implementations, the acts described herein are repeated or performed in parallel with one another or in parallel with different instances of the same or similar acts.

As mentioned, FIG. 7 illustrates a flowchart of a series of acts 700 for generating and utilizing a fused machine learning map in accordance with one or more implementations. While FIG. 7 illustrates acts according to various implementations, alternative implementations omit, add to, reorder, and/or modify any of the acts shown in FIG. 7. In one or more implementations, the acts of FIG. 7 are performed as part of a method (e.g., a computer-implemented method). Alternatively, in one or more implementations, a non-transitory computer-readable storage medium comprises instructions that, when executed by one or more processors, cause a computing device to perform the acts of FIG. 7. In some implementations, a system performs the acts of FIG. 7.

As shown in FIG. 7, the series of acts 700 includes an act 702 of generating a first machine learning map comprising a first set of machine learning similarity metrics between cell perturbations, an act 704 of generating a second machine learning map comprising a second set of machine learning similarity metrics between the cell perturbations, an act 706 of generating a fused machine learning map by using late fusion to combine the first machine learning map and the second machine learning map, and an act 708 of utilizing the fused machine learning map to determine a predicted relationship between a first perturbation and a second perturbation of the cell perturbations.

In particular, in some implementations, the act 702 includes generating a first machine learning map comprising a first set of machine learning similarity metrics between cell perturbations by comparing a first set of functional response machine learning embeddings of the cell perturbations, the act 704 includes generating a second machine learning map comprising a second set of machine learning similarity metrics between the cell perturbations by comparing a second set of functional response machine learning embeddings of the cell perturbations, the act 706 includes generating a fused machine learning map by using late fusion to combine the first machine learning map and the second machine learning map, and the act 708 includes utilizing the fused machine learning map to determine a predicted relationship between a first perturbation and a second perturbation of the cell perturbations.

For example, in some implementations, the series of acts 700 includes generating the fused machine learning map by combining the first set of machine learning similarity metrics with the second set of machine learning similarity metrics according to weights associated with the first machine learning map and the second machine learning map. Additionally, in some implementations, the series of acts 700 includes generating the fused machine learning map by: generating a first graph from the first machine learning map, the first graph comprising a first set of nodes corresponding to the cell perturbations and a first set of edge weights between the first set of nodes representing the first set of machine learning similarity metrics; and generating a second graph from the second machine learning map, the second graph comprising a second set of nodes corresponding to the cell perturbations and a second set of edge weights between the second set of nodes representing the second set of machine learning similarity metrics.

Moreover, in some implementations, the series of acts 700 includes generating the fused machine learning map by combining the first graph and the second graph to generate a fused graph comprising a third set of nodes corresponding to the cell perturbations and a third set of edge weights between the third set of nodes representing a fused set of machine learning similarity metrics. Furthermore, in some implementations, the series of acts 700 includes generating the fused machine learning map by utilizing a similarity network fusion model to iteratively update the third set of edge weights based on the first set of edge weights and the second set of edge weights to generate the fused graph from the first graph and the second graph.

Moreover, in some implementations, the series of acts 700 includes generating the fused machine learning map by: generating combined functional response machine learning embeddings by combining the first set of functional response machine learning embeddings and the second set of functional response machine learning embeddings; and comparing the combined functional response machine learning embeddings to generate fused machine learning similarity metrics.

Furthermore, in some implementations, the series of acts 700 includes generating the first machine learning map by generating the first set of machine learning similarity metrics by comparing phenomic embeddings generated from digital images of a first set of cells exposed to the cell perturbations; and generating the second machine learning map by generating the second set of machine learning similarity metrics by comparing transcriptomic embeddings generated from transcriptomic profiles of a second set of cells exposed to the cell perturbations. Additionally, in some implementations, the series of acts 700 includes generating the first machine learning map by generating the first set of machine learning similarity metrics from perturbations applied to cells of a first type; and generating the second machine learning map by generating the second set of machine learning similarity metrics for perturbations applied to cells of a second type.

Moreover, in some implementations, the series of acts 700 includes generating a first graph from the first machine learning map, the first graph comprising a first set of nodes corresponding to the cell perturbations and a first set of edge weights between the first set of nodes representing the first set of machine learning similarity metrics; generating a second graph from the second machine learning map, the second graph comprising a second set of nodes corresponding to the cell perturbations and a second set of edge weights between the second set of nodes representing the second set of machine learning similarity metrics; and combining the first graph and the second graph to generate a fused graph comprising a third set of nodes corresponding to the cell perturbations and a third set of edge weights between the third set of nodes representing a fused set of machine learning similarity metrics.

Furthermore, in some implementations, the series of acts 700 includes generating a first graph from the first machine learning map, the first graph comprising a first set of nodes corresponding to the cell perturbations and a first set of edge weights between the first set of nodes representing the first set of machine learning similarity metrics; generating a second graph from the second machine learning map, the second graph comprising a second set of nodes corresponding to the cell perturbations and a second set of edge weights between the second set of nodes representing the second set of machine learning similarity metrics; combining the first graph and the second graph to generate a fused graph comprising a third set of nodes corresponding to the cell perturbations and a third set of edge weights between the third set of nodes representing a fused set of machine learning similarity metrics; and utilizing a similarity network fusion model to iteratively update the third set of edge weights based on the first set of edge weights and the second set of edge weights to generate the fused graph from the first graph and the second graph.

In addition, in some implementations, the series of acts 700 includes generating a third machine learning map comprising a third set of machine learning similarity metrics by comparing a third set of machine learning embeddings of compound structures or gene relationships; and generating the fused machine learning map by using late fusion to combine the first machine learning map, the second machine learning map, and the third machine learning map.

In addition, in some implementations, the series of acts 700 includes generating a third machine learning map comprising a third set of machine learning similarity metrics by comparing a third set of machine learning embeddings of compound structures or gene relationships; and generating an additional fused machine learning map by using late fusion to combine the first machine learning map with an additional machine learning map (e.g., an additional compound structure machine learning map, an additional gene relationship machine learning map, or another machine learning map).

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800, may represent the computing devices described above (e.g., the server device(s) 600 or the client device(s) 610). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes the memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes the storage device 806 for storing data or instructions. As an example, and not by way of limitation, the storage device 806 can include a non-transitory storage medium described above. The storage device 806 may include a hard disk drive (“HDD”), flash memory, a Universal Serial Bus (“USB”) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include the bus 812. The bus 812 can include hardware, software, or both that connects components of computing device 800 to each other.

The components of the map fusion system 102 include software, hardware, or both. For example, the components include one or more instructions stored on a computer-readable storage medium and executable by processors of one or more computing devices, such as a client device or server device. When executed by the one or more processors, in some implementations, the computer-executable instructions of the map fusion system 102 cause the computing device(s) to perform the methods described herein. Alternatively, in one or more implementations, the components include hardware, such as a special purpose processing device to perform a certain function or group of functions. Alternatively, in some implementations, the components of the map fusion system 102 include a combination of computer-executable instructions and hardware.

Furthermore, the components of the map fusion system 102 are, for example, implemented as one or more operating systems, as one or more stand-alone applications, as one or more modules of an application, as one or more plug-ins, as one or more library functions, as one or more functions callable by other applications, and/or as a cloud-computing model. Thus, in some implementations, the components are implemented as a stand-alone application, such as a desktop or mobile application. Furthermore, in various implementations, the components are implemented as one or more web-based applications hosted on a remote server. In some implementations, the components are implemented in a suite of mobile device applications or “apps.”

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating a first machine learning map comprising a first set of machine learning similarity metrics between cell perturbations by comparing a first set of functional response machine learning embeddings of the cell perturbations;
generating a second machine learning map comprising a second set of machine learning similarity metrics between the cell perturbations by comparing a second set of functional response machine learning embeddings of the cell perturbations;
generating a fused machine learning map by using late fusion to combine the first machine learning map and the second machine learning map; and
utilizing the fused machine learning map to determine a predicted relationship between a first perturbation and a second perturbation of the cell perturbations.

2. The computer-implemented method of claim 1, wherein generating the fused machine learning map comprises combining the first set of machine learning similarity metrics with the second set of machine learning similarity metrics according to weights associated with the first machine learning map and the second machine learning map.

3. The computer-implemented method of claim 1, wherein generating the fused machine learning map comprises:
generating a first graph from the first machine learning map, the first graph comprising a first set of nodes corresponding to the cell perturbations and a first set of edge weights between the first set of nodes representing the first set of machine learning similarity metrics; and
generating a second graph from the second machine learning map, the second graph comprising a second set of nodes corresponding to the cell perturbations and a second set of edge weights between the second set of nodes representing the second set of machine learning similarity metrics.

4. The computer-implemented method of claim 3, wherein generating the fused machine learning map comprises combining the first graph and the second graph to generate a fused graph comprising a third set of nodes corresponding to the cell perturbations and a third set of edge weights between the third set of nodes representing a fused set of machine learning similarity metrics.

5. The computer-implemented method of claim 4, wherein generating the fused machine learning map comprises utilizing a similarity network fusion model to iteratively update the third set of edge weights based on the first set of edge weights and the second set of edge weights to generate the fused graph from the first graph and the second graph.

6. The computer-implemented method of claim 1, further comprising:
generating a third machine learning map comprising a third set of machine learning similarity metrics by comparing a third set of machine learning embeddings of compound structures or gene relationships; and
generating an additional fused machine learning map by using late fusion to combine the first machine learning map with an additional machine learning map.

7. The computer-implemented method of claim 1, wherein:
generating the first machine learning map comprises generating the first set of machine learning similarity metrics by comparing phenomic embeddings generated from digital images of a first set of cells exposed to the cell perturbations; and
generating the second machine learning map comprises generating the second set of machine learning similarity metrics by comparing transcriptomic embeddings generated from transcriptomic profiles of a second set of cells exposed to the cell perturbations.

8. The computer-implemented method of claim 1, wherein:
generating the first machine learning map comprises generating the first set of machine learning similarity metrics from perturbations applied to cells of a first type; and
generating the second machine learning map comprises generating the second set of machine learning similarity metrics for perturbations applied to cells of a second type.

9. A system comprising:
at least one processor; and
at least one non-transitory computer-readable storage medium storing instructions that, when executed by the at least one processor, cause the system to:
generate a first machine learning map comprising a first set of machine learning similarity metrics between cell perturbations by comparing a first set of functional response machine learning embeddings of the cell perturbations;
generate a second machine learning map comprising a second set of machine learning similarity metrics between the cell perturbations by comparing a second set of functional response machine learning embeddings of the cell perturbations;
generate a fused machine learning map by using late fusion to combine the first machine learning map and the second machine learning map; and
utilize the fused machine learning map to determine a predicted relationship between a first perturbation and a second perturbation of the cell perturbations.

10. The system of claim 9, wherein the at least one non-transitory computer-readable storage medium stores additional instructions that, when executed by the at least one processor, cause the system to generate the fused machine learning map by combining the first set of machine learning similarity metrics with the second set of machine learning similarity metrics according to weights associated with the first machine learning map and the second machine learning map.

11. The system of claim 9, wherein the at least one non-transitory computer-readable storage medium stores additional instructions that, when executed by the at least one processor, cause the system to generate the fused machine learning map by:
generating a first graph from the first machine learning map, the first graph comprising a first set of nodes corresponding to the cell perturbations and a first set of edge weights between the first set of nodes representing the first set of machine learning similarity metrics;
generating a second graph from the second machine learning map, the second graph comprising a second set of nodes corresponding to the cell perturbations and a second set of edge weights between the second set of nodes representing the second set of machine learning similarity metrics; and
combining the first graph and the second graph to generate a fused graph comprising a third set of nodes corresponding to the cell perturbations and a third set of edge weights between the third set of nodes representing a fused set of machine learning similarity metrics.

12. The system of claim 11, wherein the at least one non-transitory computer-readable storage medium stores additional instructions that, when executed by the at least one processor, cause the system to generate the fused machine learning map by utilizing a similarity network fusion model to iteratively update the third set of edge weights based on the first set of edge weights and the second set of edge weights to generate the fused graph from the first graph and the second graph.

13. The system of claim 9, wherein the at least one non-transitory computer-readable storage medium stores additional instructions that, when executed by the at least one processor, cause the system to generate the fused machine learning map by:
generating combined functional response machine learning embeddings by combining the first set of functional response machine learning embeddings and the second set of functional response machine learning embeddings; and
comparing the combined functional response machine learning embeddings to generate fused machine learning similarity metrics.

14. The system of claim 9, wherein the at least one non-transitory computer-readable storage medium stores additional instructions that, when executed by the at least one processor, cause the system to:
generate the first machine learning map by generating the first set of machine learning similarity metrics by comparing phenomic embeddings generated from digital images of a first set of cells exposed to the cell perturbations; and
generate the second machine learning map by generating the second set of machine learning similarity metrics by comparing transcriptomic embeddings generated from transcriptomic profiles of a second set of cells exposed to the cell perturbations.

15. The system of claim 9, wherein the at least one non-transitory computer-readable storage medium stores additional instructions that, when executed by the at least one processor, cause the system to:
generate the first machine learning map by generating the first set of machine learning similarity metrics from perturbations applied to cells of a first type; and
generate the second machine learning map by generating the second set of machine learning similarity metrics for perturbations applied to cells of a second type.

16. A non-transitory computer-readable medium storing instructions that, when executed by at least one processor, cause a computing device to:
generate a first machine learning map comprising a first set of machine learning similarity metrics between cell perturbations by comparing a first set of functional response machine learning embeddings of the cell perturbations;
generate a second machine learning map comprising a second set of machine learning similarity metrics between the cell perturbations by comparing a second set of functional response machine learning embeddings of the cell perturbations;
generate a fused machine learning map by using late fusion to combine the first machine learning map and the second machine learning map; and
utilize the fused machine learning map to determine a predicted relationship between a first perturbation and a second perturbation of the cell perturbations.

17. The non-transitory computer-readable medium of claim 16, further storing additional instructions that, when executed by the at least one processor, cause the computing device to generate the fused machine learning map by combining the first set of machine learning similarity metrics with the second set of machine learning similarity metrics according to weights associated with the first machine learning map and the second machine learning map.

18. The non-transitory computer-readable medium of claim 16, further storing additional instructions that, when executed by the at least one processor, cause the computing device to generate the fused machine learning map by:
generating a first graph from the first machine learning map, the first graph comprising a first set of nodes corresponding to the cell perturbations and a first set of edge weights between the first set of nodes representing the first set of machine learning similarity metrics;
generating a second graph from the second machine learning map, the second graph comprising a second set of nodes corresponding to the cell perturbations and a second set of edge weights between the second set of nodes representing the second set of machine learning similarity metrics;
combining the first graph and the second graph to generate a fused graph comprising a third set of nodes corresponding to the cell perturbations and a third set of edge weights between the third set of nodes representing a fused set of machine learning similarity metrics; and
utilizing a similarity network fusion model to iteratively update the third set of edge weights based on the first set of edge weights and the second set of edge weights to generate the fused graph from the first graph and the second graph.

19. The non-transitory computer-readable medium of claim 16, further storing additional instructions that, when executed by the at least one processor, cause the computing device to generate the fused machine learning map by:
generating combined functional response machine learning embeddings by combining the first set of functional response machine learning embeddings and the second set of functional response machine learning embeddings; and
comparing the combined functional response machine learning embeddings to generate fused machine learning similarity metrics.

20. The non-transitory computer-readable medium of claim 16, further storing additional instructions that, when executed by the at least one processor, cause the computing device to:
generate the first machine learning map by generating the first set of machine learning similarity metrics by comparing phenomic embeddings generated from digital images of a first set of cells exposed to the cell perturbations; and
generate the second machine learning map by generating the second set of machine learning similarity metrics by comparing transcriptomic embeddings generated from transcriptomic profiles of a second set of cells exposed to the cell perturbations.
